(19) United States
(12) Patent Application Publication
(10) Pub. No.: US 2026/0195648 A1
(43) Pub. Date: Jul. 9, 2026

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Kawasaki-shi (JP)

(72) Inventor: Shintaro HARADA, Yokohama Kanagawa (JP)

(73) Assignee: KABUSHIKI KAISHA TOSHIBA, Kawasaki-shi (JP)

(21) Appl. No.: 19/428,188

(22) Filed: Dec. 21, 2025

(30) Foreign Application Priority Data
Jan. 8, 2025 (JP) 2025-002700

(51) Int. Cl. G06N 20/00

(52) U.S. Cl. CPC G06N 20/00

(57) ABSTRACT

An information processing device includes hardware processors. The processors generate a second model having a second weight matrix having a first weight matrix and a block weight matrix. The first weight matrix is a parameter of a first model. The block weight matrix includes blocks. The processors calculate scores each of which indicates a degree of association between input data used for learning of the second model and each of the blocks. The processors select K blocks from the blocks by using the scores. The processors input the input data to the second model and calculate a feature quantity that is an output of the second model, by using the first weight matrix and parameters corresponding to the selected blocks. The processors update the parameters corresponding to the selected blocks in such a manner as to minimize a value of a loss function based on the feature quantity.

### CROSS-REFERENCE TO RELATED APPLICATIONS

This application is based upon and claims the benefit of priority from Japanese Patent Application No. 2025-002700, filed on Jan. 8, 2025; the entire contents of which are incorporated herein by reference.

### FIELD

Embodiments described herein relate generally to an information processing device, an information processing method, and a computer program product.

### BACKGROUND

In a natural language processing (NLP) field, there is a case where a large language model (LLM) learned by utilization of an enormous data set is used. In addition, a technique of constructing a model adjusted to be suitable for a specific domain (domain model) on the basis of a pre-learned model (base model) such as a large language model has been proposed.

For example, a technique of constructing a domain model by overwriting all parameters of a base model has been proposed. In such a technique, since all the parameters are updated, pre-learned knowledge is overwritten, and performance improvement of the model may be hindered.

In a case where the LLM or the like having a large number of parameters is used as the base model, a required memory amount may be excessive when all the parameters are updated. Thus, a technique of constructing a domain model by overwriting a part of parameters has been proposed. In such a technique, for example, since parameters are not divided, it may be difficult to interpret a model, such as to which domain each parameter corresponds.

### BRIEF DESCRIPTION OF THE DRAWINGS

FIG. 1 is a block diagram of an information processing device of an embodiment;

FIG. 2 is a view illustrating a configuration example of a weight matrix of a domain model;

FIG. 3 is a flowchart of learning processing in the embodiment;

FIG. 4 is a view illustrating an example of a confirmation screen; and

FIG. 5 is a hardware configuration diagram of the information processing device of the embodiment.

### DETAILED DESCRIPTION

According to an embodiment, an information processing device includes hardware processors. The processors generate a second model having a second weight matrix having a first weight matrix and a block weight matrix. The first weight matrix is a parameter of a first model. The block weight matrix includes blocks. The processors calculate scores each of which indicates a degree of association between input data used for learning of the second model and each of the blocks. The processors select K blocks from the blocks by using the scores. The processors input the input data to the second model and calculate a feature quantity that is an output of the second model, by using the first weight matrix and parameters corresponding to the selected blocks. The processors update the parameters corresponding to the selected blocks in such a manner as to minimize a value of a loss function based on the feature quantity.

In the following, preferable embodiments of an information processing device according to this invention will be described in detail with reference to the accompanying drawings.

The information processing device of the embodiment performs additional learning of acquiring a domain model suitable for a specific domain on the basis of a pre-learned base model. At this time, in the embodiment, a concept of blocks acquired by division of parameters (weight matrix) of the model is used. That is, the information processing device of the embodiment additionally learns the domain model by updating a parameter of a part of blocks corresponding to the domain among the plurality of blocks.

Since the parameter of the part of the blocks is updated, it is possible to suppress a memory amount (memory usage) required at the time of learning from becoming excessive. That is, the domain model can be efficiently acquired. In addition, since learning can be performed in such a manner that different blocks respectively correspond to the domains, model interpretation can be more easily executed.

Hereinafter, an example of additional learning of a neural network model used in the natural language processing field will be mainly described. An applicable model (technical field) is not limited to the model used in the natural language processing field, and may be a model in any technical field including the following models.
Model for image processing including image recognition
model for Speech Processing Including Speech recognition
Model for character recognition

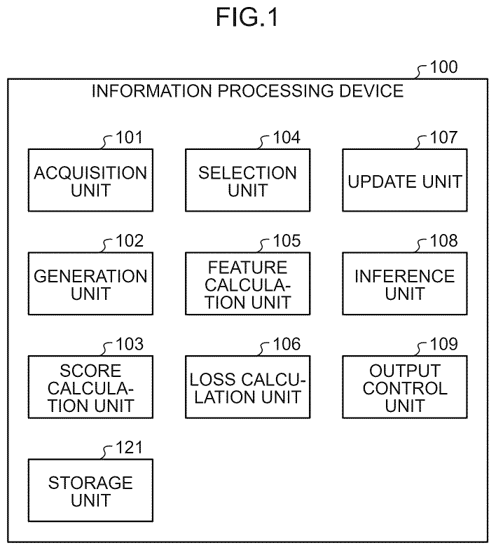

FIG. 1 is a block diagram illustrating an example of a configuration of an information processing device 100 according to an embodiment. As illustrated in FIG. 1, the information processing device 100 includes an acquisition unit 101, a generation unit 102, a score calculation unit 103, a selection unit 104, a feature calculation unit 105, a loss calculation unit 106, an update unit 107, an inference unit 108, an output control unit 109, and a storage unit 121.

The acquisition unit 101 acquires various kinds of information used in the information processing device 100. For example, the acquisition unit 101 acquires a weight matrix W^{base} (first weight matrix) that is a parameter of a base model (first model). In addition, the acquisition unit 101 acquires input data used for learning of a domain model (second model).

Note that the base model is, for example, a model constructed by training data that does not depend on a specific domain. The domain model is a model adjusted to adapt to a specific domain. The input data is data of a specific domain. The input data may be a data set including a plurality of pieces of data of the specific domain, or may be one piece of data of the specific domain.

Furthermore, the weight matrix is, for example, a parameter determined for each of one or more layers of a neural network model. The weight matrix adjusted in the present embodiment may be a part or all of one or more weight matrices corresponding to the one or more layers included in the neural network model.

A method of acquiring information by the acquisition unit 101 may be any method, and a method of receiving the information from an external device via a network, a method of reading the information from a storage medium, or the like can be applied, for example.

The generation unit 102 generates (constructs) the domain model (second model) by using the weight matrix W^{base}. Hereinafter, a case where the weight matrix W^{base} is represented by a matrix of d rows and d columns (d is an integer of 2 or more) will be described as an example. That is, W^{base}∈R^{d×d}. For example, the generation unit 102 first generates a sparse block weight matrix ΔW (∈R^{d×d}) having the same size as the weight matrix W^{base} and including a plurality of blocks.

The plurality of blocks is acquired, for example, by division of the sparse block weight matrix ΔW into n pieces in a row direction and m pieces in a column direction (n is an integer of 1 or more, m is an integer of 1 or more, and at least one of n or m is 2 or more). That is, the number of blocks is n×m. Each of the plurality of blocks has a size of d/n in the row direction and a size of d/m in the column direction. Note that the method of dividing the sparse block weight matrix ΔW is not limited to the method of dividing the sparse block weight matrix ΔW in the row direction and the column direction, and any method may be used as long as being a method of dividing the sparse block weight matrix ΔW into a plurality of blocks having the same size.

The generation unit 102 generates a domain model having, as a parameter, a weight matrix W^{domain} (second weight matrix) including the weight matrix W^{base} and the sparse block weight matrix ΔW. For example, the generation unit 102 generates the weight matrix W^{domain} of the domain model by adding the sparse block weight matrix ΔW to the weight matrix W^{base} as in the following expression (1).

W^{domain}=W^{base}+ΔW (1)

Note that “+” in the expression (1) does not mean to add values of the weight matrix, but means to generate the weight matrix of the domain model in such a manner as to include the two weight matrices. As described later, among the weight matrices of the domain model, the value of the weight matrix W^{base} is not updated and is maintained as it is, and the value of the sparse block weight matrix ΔW is updated.

Furthermore, as described later, when a feature quantity for the input data is calculated, a weight matrix set to a specific value (such as 0) indicating that values of blocks other than selected K blocks (K is an integer of 2 or more and n×m or less) are not targets is used. This weight matrix is a sparse matrix in which only the selected blocks have values. As a result, only the blocks selected from the entire blocks are adjusted to be adapted to the domain. Since it is possible to confirm which blocks (parameters) correspond to the domain, model interpretation can be more easily executed.

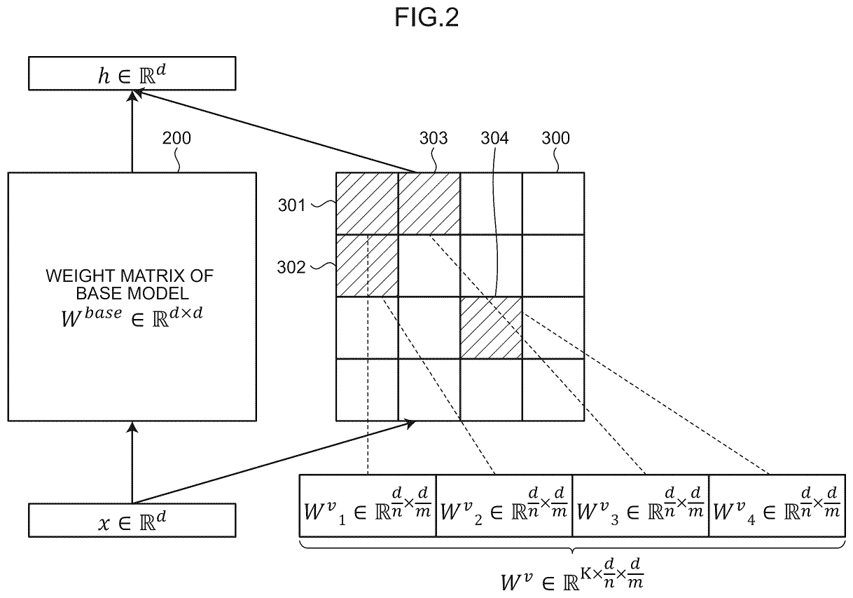

FIG. 2 is a view illustrating a configuration example of the weight matrix W^{domain} of the domain model. A weight matrix 200 corresponds to the weight matrix W^{base} of the base model. A weight matrix 300 corresponds to the sparse block weight matrix ΔW. A weight matrix including the weight matrix 200 and the weight matrix 300 corresponds to the weight matrix W^{domain}.

In the example of FIG. 2, the sparse block weight matrix ΔW is divided into 4×4 (n=4 and m=4) blocks. Furthermore, an example of a case where four (K=4) blocks are selected by the selection unit 104 (described later) is illustrated in FIG. 2. A weight matrix of a selected block having a values is represented as W^{v}ₖ (k is an integer satisfying 1≤k≤K). As will be described later, W^{v}ₖ is weighted by a score vₖ calculated for the corresponding block. A size of the weight matrix W^{v} including the weight matrices of the selected K blocks is K×(d/n)×(d/m) (W^{v}∈R^{K×(d/n)×(d/m)}). Blocks 301 to 304 are examples of blocks corresponding to the weight matrices W^{v}₁ to W^{v}₄ of the selected four blocks.

The score calculation unit 103 calculates a plurality of scores v each of which represents a degree of association between the input data used for learning of the domain model and each of the plurality of blocks. For example, the scores v are calculated in such a manner that a value increases as the degree of association with the input data increases. The scores v may be calculated by any method. For example, the scores v may be calculated by new introduction of a weight matrix, or may be a “Sensitivity-based Importance Score” described in Wang, Haoyu, et al., “RoseLoRA: Row and Column-wise Sparse Low-rank Adaptation of Pre-trained Language Model for Knowledge Editing and Fine-tuning”, arXiv: 2406.10777v 3, 15 Oct. 2024.

The selection unit 104 selects the K blocks from the plurality of blocks by utilization of the plurality of scores v. For example, the selection unit 104 selects the K blocks in which the top K scores v are calculated in descending order in the degree of association with the input data.

The feature calculation unit 105 inputs the input data to the domain model and calculates a feature quantity h that is an output of the domain model with respect to the input data. At this time, the feature calculation unit 105 calculates the feature quantity, which is the output of the domain model, by using the weight matrix W^{base} and the parameters corresponding to the selected K blocks in the weight matrix W^{domain} of the domain model.

Using the parameters corresponding to the selected K blocks corresponds to using the block weight matrix ΔW in which the values of the blocks other than the selected K blocks are set to a specific value (such as 0) indicating that the blocks are not targets of the feature quantity calculation. Hereinafter, the weight matrix in which the specific value is set is also represented as the sparse block weight matrix ΔW.

When the input data is represented by x, the feature calculation unit 105 calculates the feature quantity h by the following expression (2). The sparse block weight matrix ΔW is expressed by, for example, the following expression (3). Note that as illustrated in FIG. 2, the input data x and the feature quantity h are, for example, data of a size d.

h=W^{base}x+ΔWx (2)

ΔW=Sparse(p, vW^{v}) (3)

Sparse( ) is a function that constructs a sparse matrix. p indicates positions of the selected K blocks. v is a vector having the scores v₁ to v_{K} of the selected K blocks as elements. As described above, in the expression (3), weights based on the scores are given to the weight matrices of the K blocks. vW^{v} is expressed by, for example, the following expression (4).

vW^{v}=[v₁W^{v}₁, v₂W^{v}₂, . . . , vₖW^{v}ₖ] (4)

Sparse( ) outputs the sparse block weight matrix ΔW that includes a weight matrix, in which the scores are given as the weights to the weight matrices W^{v} 1 to W^{v} k of the K blocks at the position indicated by p, and in which the values of the non-selected blocks are set to the specific value.

The loss calculation unit 106 calculates a loss Lₜₒₜₐₗ that is a value of a loss function based on the calculated feature quantity. For example, the loss calculation unit 106 calculates the loss Lₜₒₜₐₗ by the following expression (5).

Lₜₒₜₐₗ=L_{base}+α×L_{auxiliary} (5)

L_{base} is a loss calculated by a loss function corresponding to the base model. The loss function corresponding to the base model may be any conventionally-used loss function, and is, for example, a function that outputs a larger value as a difference between the output of the base model in the feature quantity h and correct data included in the training data is larger.

L_{auxiliary} is a loss calculated by a loss function corresponding to the sparse block weight matrix ΔW (block weight matrix expressed by the expression of (3) by utilization of W^{v}). The loss function corresponding to the block weight matrix ΔW may be any conventionally used loss function, and is, for example, a function that outputs a larger value as the difference between the output of the feature quantity h by the block weight matrix ΔW and the correct data included in the training data is larger.

L_{auxiliary} can be interpreted to correspond to a loss for controlling the blocks. α is a coefficient of adjusting how much L_{auxiliary} is considered. In other words, the coefficient α corresponds to a coefficient that adjusts at least one of the positions or scores of the K blocks with respect to the domain model. By setting α=0, it is possible to adopt a configuration in which L_{auxiliary} is not used (K blocks are not explicitly controlled). As the value of α becomes larger, a degree of control of the weight matrix W^{v} of the selected blocks (K blocks) in the weight matrix W^{domain} of the domain model becomes larger.

The loss is not limited to the value calculated by the expression (4). For example, a loss by the following loss function may be further used.
A loss function that outputs a larger value as there are more overlaps in blocks selected for input data of different domains: it becomes possible to perform control in such a manner that there is no bias in selection of blocks for each domain.
A loss function that outputs a larger value as a difference between a block designated in advance for a specific domain and selected blocks becomes larger: it becomes possible for a user to control to which block the input data of the specific domain is allocated.

The update unit 107 updates a parameter corresponding to the weight matrix W^{v} of the selected blocks in the sparse block weight matrix ΔW in such a manner as to minimize the loss Lₜₒₜₐₗ (value of the loss function). At this time, the update unit 107 does not change the weight matrix W^{base} of the base model. As described above, since only the parameter of the part of the blocks is updated, it is possible to suppress the memory amount required at the time of learning from becoming excessive.

The method of minimizing the loss may be any method used for updating the parameter of the neural network model, and a backpropagation method or the like can be used, for example.

Note that a target of the update is the weight matrix W^{v} of the selected blocks in the sparse block weight matrix ΔW.

The update unit 107 stores only the value of the updated weight matrix W^{v} of the learnable block in the storage unit 121. Since not being updated, the weight matrix W^{base} of the base model does not need to be stored again.

The inference unit 108 executes inference using the learned domain model. For example, the inference unit 108 constructs the domain model including the weight matrix W^{base} of the base model and the sparse block weight matrix ΔW, and uses the constructed domain model for the inference.

The output control unit 109 controls an output of various kinds of information used in the information processing device 100. For example, the output control unit 109 outputs a result of the inference by the inference unit 108. The output control unit 109 may output the plurality of scores v respectively calculated for the plurality of blocks. An output method of the information may be any method, and a method of displaying the information on a display device, a method of transmitting the information to an external device via a network, and the like can be applied, for example.

At least a part of the units (acquisition unit 101, generation unit 102, score calculation unit 103, selection unit 104, feature calculation unit 105, loss calculation unit 106, update unit 107, inference unit 108, and output control unit 109) may be realized by one or more processing units. The above units are realized, for example, by one or a plurality of processors. For example, the above units may be realized by a processor such as a central processing unit (CPU) and a graphics processing unit (GPU) caused to execute a program, that is, by software. The above units may be realized by a processor such as a special integrated circuit (IC), that is, by hardware. The above units may be realized by utilization of software and hardware in combination. In a case where a plurality of the processors is used, each of the processors may realize one of the units or two or more of the units.

The storage unit 121 stores the various kinds of information used in the information processing device. For example, the storage unit 121 stores various kinds of information (weight matrix W^{base}, input data, and the like) acquired by the acquisition unit 101 and the updated value of the sparse block weight matrix ΔW.

Note that the storage unit 121 can include any of generally-used storage media such as a flash memory, a memory card, a random access memory (RAM), a hard disk drive (HDD), and an optical disk.

The information processing device 100 may be physically configured by one device or may be physically configured by a plurality of devices. For example, the information processing device 100 may be constructed on a cloud environment. Furthermore, the units in the information processing device 100 may be dispersedly included in a plurality of devices. For example, the information processing device 100 (information processing system) may be configured to include a device including functions necessary for learning (such as the acquisition unit 101 to the update unit 107) (such as a learning device), and a device including functions necessary for inference (such as the inference unit 108) (such as the inference device).

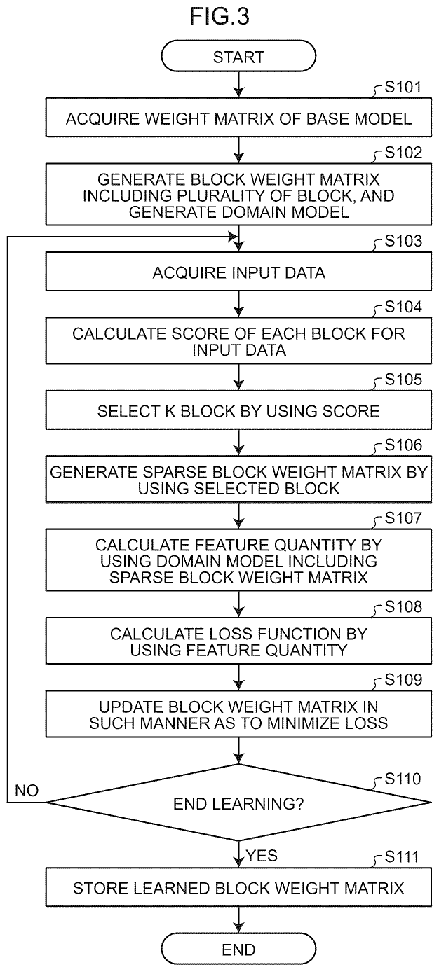

Next, learning processing by the information processing device 100 of the embodiment will be described. The learning processing is processing of learning and constructing the domain model on the basis of the base model. FIG. 3 is a flowchart illustrating an example of the learning processing in the embodiment.

The acquisition unit 101 acquires the weight matrix W^{base} of the base model (Step S101). The generation unit 102 generates the sparse block weight matrix ΔW including the plurality of blocks, and generates the domain model in which the weight matrix W^{domain} including the weight matrix W^{base} and the sparse block weight matrix ΔW is the parameter (Step S102).

The acquisition unit 101 acquires the input data (Step S103). The score calculation unit 103 calculates the plurality of scores v between the input data and each of the plurality of blocks (Step S104). The selection unit 104 selects the K blocks from the plurality of blocks by utilization of the plurality of scores v (Step S105).

The feature calculation unit 105 generates the sparse block weight matrix ΔW by using the selected K blocks (Step S106). The feature calculation unit 105 calculates a feature quantity by using the domain model including the sparse block weight matrix ΔW (Step S107).

The loss calculation unit 106 calculates the loss Lₜₒₜₐₗ that is a value of the loss function by using the calculated feature quantity (Step S108). The update unit 107 updates the block weight matrix ΔW (weight matrix W^{v} of the selected blocks) in such a manner as to minimize the calculated loss (Step S109).

The update unit 107 determines whether to end the learning (Step S110). For example, in a case where the value of the loss Lₜₒₜₐₗ is equal to or less than a threshold, in a case where the number of repetitions of update processing from Step S103 to Step S109 reaches a prescribed value, or in a case where the processing based on all pieces of the input data used for the learning is completed, the update unit 107 determines to end the learning.

In a case where the learning is not ended (Step S110: No), the processing returns to Step S103, and the processing is repeated for a next piece of the input data. In a case where the learning is ended (Step S110: Yes), the output control unit 109 stores the learned block weight matrix ΔW (weight matrix W^{v} of the selected blocks) in the storage unit 121 (Step S111), and ends the learning processing.

The output control unit 109 may display, on the display device or the like, a confirmation screen on which correspondence between the plurality of blocks and domains can be confirmed. The display device is, for example, a liquid crystal display. The display device may be included in the information processing device 100 or may be included in an external device (such as a personal computer, mobile terminal, or the like) connected to the information processing device 100 via a network or the like.

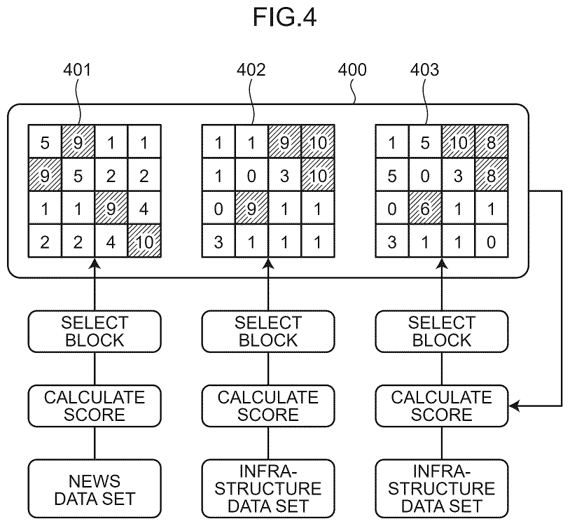

FIG. 4 is a view illustrating an example of the confirmation screen 400. The confirmation screen 400 of FIG. 4 includes patterns 401, 402, and 403 of four (K=4) blocks selected for each of data sets of three pieces of input data. The numerical value in the block represents a score calculated for the block. In each pattern, four blocks having larger score values are selected among 4×4 (=16) blocks. In such a manner, the output control unit 109 outputs the confirmation screen 400 including the plurality of scores v respectively calculated for the plurality of blocks.

A pattern 401 indicates a pattern of blocks selected for a data set of input data a domain of which is “news”. Patterns 402 and 403 indicate patterns of blocks selected for a data set of input data a domain of which is “infrastructure”.

In the learning processing, it is expected that the same block is selected for input data (data set) of the same domain. In addition, different blocks are expected to be selected for a plurality of pieces of input data (data sets) of different domains. The patterns 401 to 403 in FIG. 4 are examples in which blocks are selected as expected.

The user can more easily interpret the domain model with the confirmation screen 400. The confirmation screen 400 may further include a function with which the user or the like can instruct to execute the learning processing again according to a result of the confirmation (button or the like).

The output control unit 109 may output the confirmation screen 400 at the time of the execution of the learning processing (for example, after Step S111 in FIG. 3), or may output the confirmation screen 400 at the time of the inference by the inference unit 108.

As described above, according to the embodiment, it is possible to efficiently acquire a model in which a base model is adjusted and for which a model interpretation can be more easily executed.

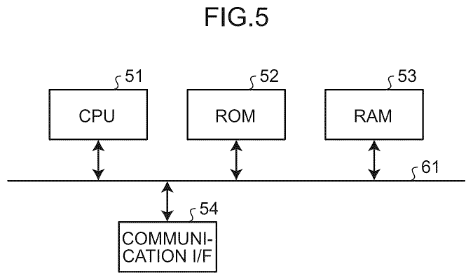

Next, a hardware configuration of the information processing device of the embodiment will be described with reference to FIG. 5. FIG. 5 is an explanatory diagram illustrating a hardware configuration example of the information processing device of the embodiment.

The information processing device of the embodiment includes a control device such as a central processing unit (CPU) 51, storage devices such as a read only memory (ROM) 52 and a random access memory (RAM) 53, a communication I/F 54 that is connected to a network and performs communication, and a bus 61 that connects the respective units.

A program executed by the information processing device of the embodiment is provided by being incorporated in the ROM 52 or the like in advance.

The program executed in the information processing device of the embodiment may be recorded, as a file in an installable format or an executable format, into a computer-readable recording medium such as a compact disk read only memory (CD-ROM), a flexible disk (FD), a compact disk recordable (CD-R), or a digital versatile disk (DVD), and provided as a computer program product.

Moreover, the program executed in the information processing device of the embodiment may be stored on a computer connected to a network such as the Internet and may be provided by being downloaded via the network. In addition, the program executed in the information processing device of the embodiment may be provided or distributed via the network such as the Internet.

The program executed in the information processing device of the embodiment may cause a computer to function as each of the units of the information processing device described above. In this computer, the CPU 51 can read the program from the computer-readable storage medium onto a primary storage device and perform execution thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to:
generate a second model having, as a parameter, a second weight matrix having a first weight matrix and a block weight matrix, the first weight matrix being a parameter of a first model, the block weight matrix having a same size as the first weight matrix and including a plurality of blocks;
calculate a plurality of scores, each of the scores indicating a degree of association between input data used for learning of the second model and each of the plurality of blocks;
select K blocks from the plurality of blocks by using the plurality of scores, K being an integer of 2 or more;
input the input data to the second model and calculate a feature quantity, the feature quantity being an output of the second model, by using the first weight matrix in the second weight matrix and parameters corresponding to the selected blocks; and
update the parameters corresponding to the selected blocks in the second weight matrix in such a manner as to minimize a value of a loss function based on the feature quantity.

2. The information processing device according to claim 1, wherein
the one or more hardware processors are further configured to:
outputting the plurality of scores respectively calculated for the plurality of blocks.

3. The information processing device according to claim 1, wherein
the loss function includes a coefficient of adjusting at least one of positions or the scores of the K blocks with respect to the second model.

4. The information processing device according to claim 1, wherein
the loss function includes a loss function of outputting a larger value as there are more overlaps in the blocks selected for a plurality of pieces of the input data of different domains.

5. The information processing device according to claim 1, wherein
the loss function includes a loss function of outputting a larger value as a difference between a block designated for a specific domain and the selected blocks is larger.

6. The information processing device according to claim 1, wherein
the plurality of blocks has a same size.

7. The information processing device according to claim 1, wherein
the first model is a model constructed by training data independent of a specific domain,
the second model is a model adjusted to be adapted to the specific domain, and
the input data is data of the specific domain.

8. A computer program product having a non-transitory computer readable medium including instructions stored thereon, wherein the instructions, when executed by a computer, cause the computer to execute:
generating a second model having, as a parameter, a second weight matrix including a first weight matrix and a block weight matrix, the first weight matrix being a parameter of a first model, the block weight matrix having a same size as the first weight matrix and including a plurality of blocks;
calculating a plurality of scores, each of the scores indicating a degree of association between input data used for learning of the second model and each of the plurality of blocks;
selecting K blocks from the plurality of blocks by using the plurality of scores, K being an integer of 2 or more;
inputting the input data to the second model and calculating a feature quantity, the feature quantity being an output of the second model, by using the first weight matrix in the second weight matrix and parameters corresponding to the selected blocks; and
updating the parameters corresponding to the selected blocks in the second weight matrix in such a manner as to minimize a value of a loss function based on the feature quantity.

9. An information processing method to be executed by an information processing device, the method comprising:
generating a second model having, as a parameter, a second weight matrix including a first weight matrix and a block weight matrix, the first weight matrix being a parameter of a first model, the block weight matrix having a same size as the first weight matrix and including a plurality of blocks;
calculating a plurality of scores, each of the scores indicating a degree of association between input data used for learning of the second model and each of the plurality of blocks;
selecting K blocks from the plurality of blocks by using the plurality of scores, K being an integer of 2 or more;
inputting the input data to the second model and calculating a feature quantity, the feature quantity being an output of the second model, by using the first weight matrix in the second weight matrix and parameters corresponding to the selected blocks; and
updating the parameters corresponding to the selected blocks in the second weight matrix in such a manner as to minimize a value of a loss function based on the feature quantity.
